(19) United States
(12) Patent Application Publication
(10) Pub. No.: US 2009/0137690 A1
(43) Pub. Date: May 28, 2009

(54) Delinked Polymer Modified Bitumen and Method of Producing Same

(75) Inventor: James J. Barnat, Tulsa, OK (US)

Correspondence Address: HEAD, JOHNSON & KACHIGIAN, 228 W 17TH PLACE, TULSA, OK, 74119, US

(73) Assignee: SEMMATERIALS, L.P., Tulsa, OK (US)

(21) Appl. No.: 12/276,479

(22) Filed: Nov. 24, 2008

Related U.S. Application Data
(60) Provisional application No. 60/990,187, filed on Nov. 26, 2007.

(51) Int. Cl. C08J 11/16; C08L 95/00

(52) U.S. Cl. 521/41; 524/59; 524/66; 524/71

(57) ABSTRACT

A delinked polymer modified bitumen comprising a delinked polymer-bitumen composite and additional bituminous material. The delinked polymer-bitumen composite comprises sulfur-cured elastomeric material having a vulcanized network and a plurality of polymer backbones; at least one rubber accelerator and at least one activator in sufficient quantities to delink the vulcanized network of the sulfur-cured elastomeric material; and at least one bituminous material, where the sulfur-cured elastomeric material, the rubber accelerator, the activator, and the bituminous material are mixed under high shear conditions at a temperature greater than 70° C. to produce the delinked polymer-bitumen composite.

### CROSS REFERENCE

This application claims priority to U.S. Provisional Application Ser. No. 60/990,187 filed Nov. 26, 2007.

### FIELD OF THE INVENTION

The present invention relates to a pre-dispersed delinked polymer-bitumen composite, a delinked polymer modified bitumen, and methods of providing the pre-dispersed delinked polymer-bitumen composite and the delinked polymer modified bitumen by delinking or opening up vulcanized rubber and introducing bitumen to the delinked vulcanized rubber to provide the polymer modified bitumen.

### DESCRIPTION OF THE RELATED ART

Recycling of reclaimed rubber from used rubber products is well known in the industry. Such rubber must be processed to reverse the effects of vulcanization to render the reclaimed rubber usable. Vulcanization is a chemical reaction of sulfur or other vulcanizing agents with rubber to cause a cross-linking of the polymer chains in the rubber to increase the strength and resiliency of the polymer system. This process is also known as cure.

When recycling elastomeric material, other agents are used, such as accelerators and activators, to assist the processing and properties of the sulfur-cured elastomeric material. Traditional accelerators include dithiocarbamates, guanidines, sulfonamides, thiozoles, thiourea, and thiurams. Traditional activators are zinc oxide and zinc salts of carboxylic acids. The combinations of accelerators and activators create the ability to attack sulfur-sulfur bonds, creating a sulfur radical that reacts unsaturated bonds in the elastomer backbone. Prior art teaches various procedures for delinking sulfur-cured elastomers. Patents to Tang, U.S. Pat. Nos. 7,250,451 and 6,590,042, Alsdorf et al., U.S. Pat. No. 6,924,319, and Sekharet al., U.S. Pat. No. 5,770,632, all incorporated herein by reference, define similar “reclaiming agents” and different processes for reclaiming sulfur-cured vulcanized rubber. The “reclaiming agent” is a vulcanization accelerator package common to the rubber industry. Accelerators and ultra-accelerators attack sulfur-sulfur bonds, creating free radicals on the surface. When a solid particle, like a reclaimed sulfur-cured elastomer, is treated with this “reclaiming agent” and process, the reactions with sulfur are only a surface phenomena and the bulk of the sulfur bridges are intact inside the core of the sulfur-cured elastomer particle. The resulting delinked sulfur-cured elastomer is thus only partially delinked.

Polymer modified bitumen is well known in the art for use in road building applications, such as applying pavement to a surface. Polymer modifiers are added to bitumen to provide the pavement with desirable properties. In particular, the use of sulfur-cured elastomers is extensive in the road paving industry. However, polymerization of bitumen requires homogeneity of the polymer system within the bituminous material. The ring and ball separation test ASTM D 7173-05 measures the separation of the polymers from the bitumen upon heated storage and is a test for homogeneity. Maldonado et al, U.S. Pat. No. 4,242,246, incorporated herein by reference, teaches various sulfur-curable elastomers and modifiers for the modification of bitumen. Due to the relative insolubility of sulfur-cured elastomers in bitumen, processes have been developed to add sufficient heat and mechanical energy to break down the polymer system via chain scissioning. Once the sulfur-cured elastomers are broken down, the remnants are free to disperse into the bituminous medium. The shortcoming of these processes is in the partial if not total destruction of the polymer system. The resulting modification of bitumen requires an exorbitant amount of polymer to achieve minimal theological results.

Utilization of the teachings of Tang, Shekhar, or Alsdorf, when applied to the modification of bitumen, creates an unstable system that is not homogeneous. Since the preponderance of the sulfur bridges remain intact within the core of the sulfur-cured elastomer or polymer, it is not suitable for the polymerization of bitumen due to the cured nature and a total lack of solubility. A separation test reveals the gross incompatibility where the sulfur-cured elastomer or polymer that is not delinked separates immediately. The shortcoming of those teachings revolves around the inability to impact more than the exterior surface of the sulfur-cured elastomer or polymer to be reclaimed and not delinking a substantial number of the sulfur bridges. Swelling the sulfur-cured elastomer or polymer before or during the treatment with the “reclaiming agent” is not effective in delinking the core of the elastomer of polymer to be reclaimed.

Accordingly, it would be desirable to provide a delinked polymer modified bitumen wherein the sulfur-cured elastomeric material utilized is more fully delinked and thus more stable. It would further be desirable to provide a delinked polymer-bitumen composite that is prc-distributed and thus produces greater homogeneity of the polymer system within the bituminous material when combined with additional bituminous material to produce a delinked polymer modified bitumen. Finally, it would be desirable to provide a method for producing such a delinked polymer-bitumen composite and delinked polymer modified bitumen.

### SUMMARY OF THE INVENTION

In general, in a first aspect, the present invention relates to a method of producing a delinked polymer-bitumen composite, the method comprising the steps of: feeding a sulfur-cured elastomeric material having a vulcanized network and a plurality of polymer backbones into a mixing device; adding at least one rubber accelerator and at least one activator in sufficient quantities to delink the vulcanized network of the sulfur-cured elastomeric material and produce a reclaimed elastomeric material; adding at least one bituminous material; and mixing the sulfur-cured elastomeric material, the rubber accelerator, the activator, and the bituminous material under high shear conditions and at a temperature greater than 70° C. to produce the delinked polymer-bitumen composite.

The method may further comprise at least partially delinking the vulcanized network of the sulfur-cured elastomeric material and producing a reclaimed elastomeric material. The delinking may occur after adding the bituminous material, or the addition of bituminous material may occur during the delinking. The addition of the rubber accelerator and activator occurs prior to feeding the sulfur-cured elastomeric material into the mixing device. Alternately, the addition of the rubber accelerator and activator occurs concurrent to the feeding the sulfur-cured elastomeric material into the mixing device.

The activator may comprise metal oxides, zinc di-2-ethylhexoate, zinc di-2-ethyloctoate, derivatives thereof, or combinations thereof and the like. The metal oxide may be zinc oxide, magnesium oxide, derivatives thereof, or combinations thereof. A diol or an alcohol may be added along with the activator. The sulfur-cured elastomeric material may comprise recycled rubber products, and may comprise natural rubber, synthetic rubber, styrene-butadiene rubber, or combinations thereof, which were originally vulcanized by a conventional sulfur-accelerated vulcanizing system.

The rubber accelerator may comprise dithiocarbamates, guanidines, sulfonamides, thiozoles, thiourea, thiurams, derivatives thereof, or combinations thereof. The dithiocarbamates may be metal salts of dimethyldithiocarbamate, diethyldithiocarbamate, dibutyldithiocarbamate, diamyldithiocarbamate, derivatives thereof, or combinations thereof, where the metal is zinc, bismuth, cadmium, copper, lead, or any other transitional metal from groups 3 through 12, other metal from groups 13 through 15, metalloids, or selenium. The guanidines may be N,N′-di-ortho-tolyquanine or N,N′-diphenyl-gaunidine and the like. The sulfenamides may be N-cyclohexyl-2-benzothiazolesulfenamide or 4-morpholinyl-2-benzothiayl disulfide and the like. The thiozoles may be 2-mercaptobenzothiazole or benzothiazyl disulfide, and the 2-mercaptobenzothiazole may be zinc 2-mercaptobenzothiazole and the like. The thiourea may be trimethylthiourea or 1,3-Diethylthiourea and the like. The thiurams may be tetramethylthiuram disulfide, tetraethylthiuram disulfide, or tetrabutylthiuram disulfide and the like. Cadmium or other metals, metalloids, or Selenium may be substituted for zinc implemented in the rubber accelerator, the activator, or both.

Mixing may occur at a pressure less than about 10,000 psi. The mixing device may be capable of withstanding operating temperatures greater than about 70° C. and operating pressures in a range of from about 50 psi to about 5,000 psi. The mixing device may be an extruder, which may be a single screw type or a double screw type, which may be a co-rotating type or a counter rotating type. The mixing device may be operable at a shear rate of greater than about 1,000 s⁻¹ at about atmospheric pressure, and may be operated at a shear rate of greater than about 1,500 s⁻¹. If so, the delinked polymer-bitumen composite may be processed in laminar flow.

The sulfur-cured elastomeric material, the rubber accelerator, the rubber activator, and the bituminous material may be subjected to a scalar shear quantity that is greater than about 250. The sulfur-cured elastomeric material, the rubber accelerator, the rubber activator, and the bituminous material may be subjected to a scalar shear quantity that is greater than about 1,000 or 2,500, and may be subjected to a specific energy of greater than about 0.025 kW/kg, 0.05 kW/kg, or 0.10 kW/kg.

The rubber accelerator and the rubber activator may be added to the mixing device at more than one location within the mixing device. If the mixing device is an extruder, the rubber accelerator may be added to the extruder along the length of the extruder. Mixing may occur at a temperature of greater than 100° C. or greater than 125° C.

The bitumen may be petroleum based asphalt, asphalt cement, pitch, coal tar, asphalt, vacuum tar bottoms, resid, performance grade asphalt, flux, petroleum products, other hydrocarbons, or combinations thereof.

The method may further comprise recovering the delinked polymer-bitumen composite from the mixing device and transforming the delinked polymer-bitumen composite into a form that is suitable for storage and transportation. The form that is suitable for storage and transportation may be pellet, particulate, particle, or combinations thereof. The method may further comprise mixing the delinked polymer-bitumen composite with additional bituminous material to produce a delinked polymer modified bitumen, and may further comprise transporting the delinked polymer-bitumen composite to a secondary mixing location prior to mixing the delinked polymer-bitumen composite with additional bituminous material.

A delinked polymer-bitumen composite may comprise sulfur-cured elastomeric material having a vulcanized network and a plurality of polymer backbones; at least one rubber accelerator and at least one activator in sufficient quantities to delink the vulcanized network of the sulfur-cured elastomeric material; and at least one bituminous material, where the sulfur-cured elastomeric material, the rubber accelerator, the activator, and the bituminous material are mixed under high shear conditions at a temperature greater than 70° C. to produce the delinked polymer-bitumen composite. A delinked polymer modified bitumen may comprise the delinked polymer-bitumen composite and additional bituminous material. Both may be subject to the same limitations set forth in the description of the method.

### DETAILED DESCRIPTION OF THE PREFERRED EMBODIMENTS

The present invention relates to a pre-dispersed delinked polymer-bitumen composite, a delinked polymer modified bitumen, and methods of providing the pre-dispersed delinked polymer-bitumen composite and the delinked polymer modified bitumen containing reclaimed elastomeric material. Broadly, effective amounts of a sulfur-cured elastomeric material having a vulcanized network and a plurality of polymer backbones are fed into a mixing device. An effective amount of a rubber accelerator (or vulcanization accelerator) and an effective amount of an activator to delink or open up the vulcanized network of the sulfur-cured elastomeric material is added to the sulfur-cured elastomeric material. The accelerator and activator are used to at least partially delink the vulcanized network of the sulfur-cured elastomeric material and produce a reclaimed elastomeric material. At least one bituminous material is added to the sulfur-cured elastomeric material, either before or during the delinking process. Mixing the sulfur-cured elastomeric material, the rubber accelerator, the activator, and the bituminous material produces a delinked polymer-bitumen composite.

The key to this process is that the bituminous material is in contact with the sulfur-cured elastomeric material while it is being delinked, and thus has the opportunity to react with and stabilize the sulfur radicals. Subsequently, the accelerator and activator have access to the next sulfur bridge, and the delinking process is able to continue at a deeper level than just on the surface. Again, the bituminous material stabilizes the free sulfur radicals, and the process continues. Thus, the presence of the bituminous material during the delinking process results in a more complete delinking of the sulfur-cured elastomeric material. Furthermore, the delinked polymer and the bituminous material become fully dispersed, which enables the easy dispersion of the resultant delinked polymer-bitumen composite into additional bitumen to create a delinked polymer modified bitumen.

The polymer backbones are protected from continued cross-linking by the bitumen, which terminates a substantial portion of free radicals, allowing for much faster rates of reaction due to the higher temperatures enabling a more complete delinking of the sulfur-cured elastomeric material. Also, the addition of bitumen permits the delinking of the sulfur-cured elastomeric material to be accomplished at temperatures significantly higher than about 70° C. It should be understood and appreciated that the bitumen can be added before or during the delinking process. Preferably, bitumen is added to the sulfur-cured elastomeric material during the delinking process to offer a reaction site thereby linking the rubber to the bitumen and terminate the newly created free radicals of the delinked rubber. Additional bitumen can be added to the pre-dispersed delinked polymer-bitumen composite to provide the delinked polymer modified bitumen. The process of delinking the sulfur-cured elastomeric material is implemented at a temperature in a range of greater than about 70° C. and a pressure less than about 10,000 psi. It should be understood and appreciated that the rubber accelerator and the activator can be added as a mixture or separately. It should also be understood and appreciated that the rubber accelerator and the activator can be introduced into the mixing device prior to, at substantially the same time as, or after the sulfur-cured elastomeric material is fed into the mixing device.

The mixing device implemented in the method of providing the pre-dispersed delinked polymer-bitumen composite can be any mixing device known in the art capable of handling the operating conditions and materials implemented in providing the pre-dispersed delinked polymer-bitumen composite. More specifically, the mixing device should be able to withstand operating temperatures greater than about 70° C. and operating pressures in a range of from about 50 psi to about 5,000 psi.

In one embodiment of the present invention, the mixing device can be a high shear device, such as an extruder. More specifically, if an extruder is implemented as the mixing device, the extruder can be either a single screw type or a double screw type. Even more specifically, if a double crew type extruder is implemented as a mixing device, the double screw type can be either a co-rotating type or a counter rotating type. Such extruders are manufactured by American Leistritz Extruder Corporation located at 169 Meister Avenue, Somerville, N.J. 08876, and by American Kuhne located at 31 Connecticut Avenue, Norwich, Conn. 06360.

In one embodiment of the present invention, the high shear devices implemented can operate at a shear rate of greater than about 1,000 s⁻¹ at about atmospheric pressure. Shear Rate is defined by:

Sᵣ=V/g

whereby; Sᵣ=the shear rate
V=the tip speed of the shearing device
g=the gap

In one embodiment of the present invention, the pre-dispersed delinked polymer-bitumen composite having a highly rheological elasticity in the high shear device is processed in laminar flow.

In fluid dynamics, there are three types of flow: laminar flow, turbulent flow, and transitional flow. In nonscientific terms, laminar flow is smooth, turbulent flow is rough, and transitional flow is a mixture of both smooth and rough flow.

The dimensionless Reynolds number is an important parameter in equations that describe whether flow conditions lead to laminar, transitional, or turbulent flow and is important in analyzing any type of flow when there is substantial velocity gradient or shear. It indicates the relative significance of the viscous effect compared to the inertia effect. The Reynolds number is proportional to the inertial forces divided by the viscous forces.

Laminar flow, which is sometimes known as streamline flow, occurs when a fluid flows in parallel layers, with no disruption between the layers. In laminar flow, the Reynolds number is less than approximately 2,300. Laminar flow is characterized by high momentum diffusion, low momentum convection, and pressure and velocity independence from time. Shear stress in laminar flow is independent of the density and the shear stress depends almost entirely on the viscosity.

Turbulent flow produces flow vortices, eddies, and wakes, which make the flow unpredictable. Turbulent flow happens in general at high flow rates. In turbulent flow, the Reynolds number is generally greater than approximately 4,000.

Transitional flow is a mixture of laminar and turbulent flow, with turbulence in the center of the pipe, and laminar flow near the edges. In transitional flow, the Reynolds number is generally between approximately 2,300-4,000. These three flows behave in different manners in terms of their frictional energy loss while flowing and have different equations that predict their behavior.

Although higher shear rates are achievable, scalar shear quantity (the product of shear rate and resident lime within this shear zone), resident time, or energy per unit mass are important for the present invention. As described herein, the sulfur-cured elastomeric material, the rubber accelerator, the activator, and the bitumen can be subjected to a wide range of scalar shear quantities while being mixed. In one embodiment of the present invention, the sulfur-cured elastomeric material, the rubber accelerator, the activator, and the bitumen are subjected to a scalar shear quantity that is greater than about 250. In another embodiment, the sulfur-cured elastomeric material, the rubber accelerator, the activator, and the bitumen are subjected to a scalar shear quantity that is greater than about 1,000. In a further embodiment, the sulfur-cured elastomeric material, the rubber accelerator, the activator, and the bitumen are subjected to a scalar shear quantity that is greater than about 2,500.

In accordance with the present invention, a wide range of energy can be utilized while mixing the sulfur-cured elastomeric material, the rubber accelerator, the activator, and the bitumen. In one embodiment of the present invention, the energy utilized while mixing the sulfur-cured elastomeric material, the rubber accelerator, the activator, and the bitumen is greater than about 0.025 kW/kg. In another embodiment of the present invention, the energy utilized while mixing the sulfur-cured elastomeric material, the rubber accelerator, the activator, and the bitumen is greater than about 0.05 kW/kg. In a further embodiment of the present invention, the energy utilized while mixing the sulfur-cured elastomeric material, the rubber accelerator, the activator, and the bitumen is greater than about 0.10 kW/kg.

In one embodiment of the present invention, the mixture of the rubber accelerator and the activator is introduced into the mixing device at various locations to increase the effectiveness of the mixture of the rubber accelerator and the activator in delinking or opening up the vulcanized network of the sulfur-cured elastomeric material thereby releasing the reclaimed elastomeric material. In one example, the mixing device is an extruder and the mixture of the rubber accelerator and the activator is successively added along the length of the extruder.

The sulfur-cured elastomeric material can be any elastomeric products made from natural rubber, synthetic rubber, styrene-butadiene rubber (SBR), or combinations thereof, which were originally vulcanized by a conventional sulfur-accelerated vulcanizing system. Examples include, but are not limited to, tire, moldings, gloves, beltings, inner tubes, etc.

The rubber accelerator can be any rubber accelerator capable of initialing a proton exchange reaction, thus promoting the delinking or opening up of the vulcanized network of the sulfur-cured elastomeric material. Examples of rubber accelerators include zinc (Zn) salts of thiocarbamates such as zinc dimethyldithiocarbamate (hereinafter “XDMC”) and 2-mercaptobenzothiazole (hereinafter “MBT”), or derivatives or combinations thereof, in the molar ratio in the range of 1:1 to 1:12 based on the molar ratio of activator (for example, zinc oxide) and accelerator (for example, MTB) with a more preferred range of 1:1.5 to 1:8.

ZDMC and MBT being mentioned above as accelerators may be replaced with other accelerators, some of which may be less active. The following, which are no means exhaustive, are examples of known accelerators that may replace ZDMC and MBT.

ZDMC may be replaced on a molar basis by other zinc salts of dithiocarbamates such as zinc dimethyldithiocarbamate (ZDMC), zinc diethyldithiocarbamate (ZDEC), zinc dipropyldithiocarbamate, zinc dibutyldithiocarbamate (ZBDC), zinc dibenzyldithiocarbamate (ZBEC), or by zinc dialkyl dithiophosphates such as zinc dibutyldithiophosphate, and other chemicals which may perform the function of rubber accelerator.

Similarly, MBT may be replaced on a molar basis by other thiazole accelerators such as benzothiazyl disulphide (MBTS), or zinc 2-mercaptobenzothiazole (ZMBT), or by sulphenamide accelerators such as N-morpholinylbenzothiazole-2-sulfenamide (MBS), N-cyclhexyl-2-benzolhiazole sulphenamide (CBS) or N-tert-butyl 2-benzothiazole sulphenamide (TBBS), or by thiuram accelerators such as tetraethylthiruam monosulfide (TMTM), tetraethylthiuram disulphide (TETD), tetramethylthiruam disulphide (TMTD) or tetrabenzylthiruam disulphide (TBTD), or by nitrogen-based accelerators such as guanidines. N,N′-diphenylguanidine, d-ortho-tolylguanidine, and 4,4′-dithiomorpholine, or any other chemicals which may perform the function of rubber accelerator. It should be appreciated that other metals, metalloids, or Selenium can be substituted for the zinc implemented in the rubber accelerators described herein.

The activator can be any activator capable of activating the rubber accelerator so as to initiate the proton exchange reaction, thus promoting the delinking or opening up of the vulcanized network of the sulfur-cured elastomeric material. Examples of activators include stearic acid, zinc salts of fatty acids, zinc oxide, and combinations thereof. It should be appreciated that other metals, metalloids, or Selenium can be substituted for the zinc implemented in the rubber activators described herein.

Similarly, the presence of a diol or an alcohol may aid in the delinking or the opening up of the vulcanized network of the sulfur-cured elastomeric material.

The sulfur-cured elastomeric material is fed into the mixing device in an amount sufficient to produce a predetermined amount of the pre-dispersed delinked polymer-bitumen composite. The rubber accelerator is present in the mixture of the rubber accelerator and the activator in an amount sufficient to initiate the proton exchange and delink or open up the vulcanized network of the sulfur-cured elastomeric material. The activator is present in the mixture of the rubber accelerator and the activator in an amount sufficient to activate the rubber accelerator and the activator in an amount sufficient to activate the rubber accelerator so as to initiate the proton exchange reaction, thus promoting the delinking or opening up of the vulcanized network of the sulfur-cured elastomeric material.

The bitumen implemented in the present invention can be any bitumen or bituminous material known in the art suitable for mixing with any polymer material. Examples of suitable bitumen include, but are not limited to, petroleum based asphalt, asphalt cement (AC), pitch, coal tar, asphalt, vacuum tar bottoms (VTB), resid, performance grade (PG) asphalts, flux, petroleum products, other hydrocarbons, and combinations thereof. The amount of bitumen introduced into the mixing device is any amount sufficient to produce a predetermined amount of reclaimed polymer modified bitumen having a predetermined concentration of reclaimed elastomeric material.

Once the pre-dispersed delinked polymer-bitumen composite is recovered from the mixing device, the pre-dispersed delinked polymer-bitumen composite is transformed into a form that is suitable for storage and transportation. Examples of forms suitable for storage and transportation include, but are not limited to, pellet, particulate, particle, and combinations thereof. The pre-dispersed delinked polymer-bitumen composite produced by the method disclosed herein is stable at normal temperatures, thus they can be transported and stored without heating.

In a further embodiment of the present invention, the pre-dispersed delinked polymer-bitumen composite, after being transformed, can be transported to a secondary mixing location and mixed with the additional bitumen, asphalt, or other hydrocarbon at the secondary mixing location. The pre-dispersed delinked polymer-bitumen composite is mixed with the additional bitumen to produce the delinked polymer modified bitumen.

In another embodiment of the present invention, the pre-dispersed delinked polymer-bitumen composite is used without a secondary addition of bitumen, asphalt, or other hydrocarbon.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A method of producing a delinked polymer-bitumen composite, the method comprising the steps of:
feeding a sulfur-cured elastomeric material having a vulcanized network and a plurality of polymer backbones into a mixing device;
adding at least one rubber accelerator and at least one activator in sufficient quantities to delink the vulcanized network of the sulfur-cured elastomeric material and produce a reclaimed elastomeric material;
adding at least one bituminous material; and
mixing the sulfur-cured elastomeric material, the rubber accelerator, the activator, and the bituminous material under high shear conditions and at a temperature greater than 70° C. to produce the delinked polymer-bitumen composite.

2. The method of claim 1 further comprising at least partially delinking the vulcanized network of the sulfur-cured elastomeric material and producing a reclaimed elastomeric material.

3. The method of claim 2 where the delinking occurs after adding the bituminous material.

4. The method of claim 2 where adding the bituminous material occurs during the delinking.

5. The method of claim 1 where adding the rubber accelerator and activator occurs prior to feeding the sulfur-cured elastomeric material into the mixing device

6. The method of claim 1 where the activator comprises metal oxides, zinc di-2-ethylhexoate, zinc di-2-ethyloctoate, derivatives thereof, or combinations thereof.

7. The method of claim 6 where the metal oxide is zinc oxide, magnesium oxide, derivatives thereof, or combinations thereof.

8. The method of claim 1 further comprising adding a diol or an alcohol along with the activator.

9. The method of claim 1 where the sulfur-cured elastomeric material comprises recycled rubber products.

10. The method of claim 1 where the sulfur-cured elastomeric material comprises natural rubber, synthetic rubber, styrene-butadiene rubber, or combinations thereof.

11. The method of claim 1 where the rubber accelerator comprises dithiocarbamates, guanidines, sulfenamides, thiozoles, thiourea, thiurams, derivatives (hereof, or combinations thereof.

12. The method of claim 11 where the dithiocarbamates are metal salts of dimethyldithiocarbamate, diethyldithiocarbamate, dibutyldithiocarbamate, diamyldithiocarbamate, derivatives thereof, or combinations thereof, where the metal is zinc, bismuth, cadmium, copper, lead, or any other transitional metal from groups 3 through 12, other metal from groups 13 through 15, metalloids, or selenium.

13. The method of claim 11 where the guanidines are N,N′-di-ortho-tolyquanine or N,N′-diphenyl-gaunidine.

14. The method of claim 11 where the sulfenamides are N-cyclohexyl-2-benzothiazolesulfenamide or 4-morpholinyl-2-benzothiayl disulfide.

15. The method of claim 11 where the thiozoles are 2-mercaptobenzothiazole or benzothiazyl disulfide.

16. The method of claim 15 where the 2-mercaptobenzothiazole is zinc 2-mercaptobenzothiazole.

17. The method of claim 11 where the thiourea is trimethylthiourea or 1,3-Diethylthiourea.

18. The method of claim 11 where the thiurams are tetramethylthiuram disulfide, tetraethylthiuram disulfide, or tetrabutylthiuram disulfide.

19. The method of claim 11 where cadmium or magnesium is substituted for zinc implemented in the rubber accelerator, the activator, or both and combinations thereof.

20. The method of claim 1 where the mixing occurs at a pressure less than about 10.000 psi.

21. The method of claim 1 where the mixing device is capable of withstanding operating temperatures greater than about 70° C. and operating pressures in a range of from about 50 psi to about 5,000 psi.

22. The method of claim 1 where the mixing device is an extruder.

23. The method of claim 22 where the extruder is a single screw type.

24. The method of claim 22 where the extruder is a double screw type.

25. The method of claim 24 where the extruder is a co-rotating type.

26. The method of claim 24 where the extruder is a counter rotating type.

27. The method of claim 1 where the mixing device can operate at a shear rate of greater than about 1,000 s⁻¹ at about atmospheric pressure.

28. The method of claim 27 where the mixing device is operated at a shear rate of greater than about 1,500 s⁻¹.

29. The method of claim 28 further comprising processing die delinked polymer-bitumen composite in laminar flow.

30. The method of claim 1 where the sulfur-cured elastomeric material, the rubber accelerator, the activator, and the bituminous material are subjected to a scalar shear quantity that is greater than about 250.

31. The method of claim 1 where the sulfur-cured elastomeric material, the rubber accelerator, the activator, and the bituminous material are subjected to a scalar shear quantity that is greater than about 1,000.

32. The method of claim 1 where the sulfur-cured elastomeric material, the rubber accelerator, the activator, and the bituminous material are subjected to a scalar shear quantity that is greater than about 2,500.

33. The method of claim 1 where the sulfur-cured elastomeric material, the rubber accelerator, the activator, and the bituminous material are subjected to a specific energy of greater than about 0.025 kW/kg.

34. The method of claim 1 where the sulfur-cured elastomeric material, the rubber accelerator, the activator, and the bituminous material are subjected to a specific energy of greater than about 0.05 kW/kg.

35. The method of claim 1 where the sulfur-cured elastomeric material, the rubber accelerator, the activator, and the bituminous material are subjected to a specific energy of greater than about 0.10 kW/kg.

36. The method of claim 1 where the rubber accelerator and the activator are added to the mixing device at more than one location within the mixing device.

37. The method of claim 36 where the mixing device is an extruder and the rubber accelerator and the activator are added to the extruder along the length of the extruder.

38. The method of claim 1 where the mixing occurs at a temperature greater than 100° C.

39. The method of claim 1 where the mixing occurs at a temperature greater than 125° C.

40. The method of claim 1 where the bituminous material is bitumen.

41. The method of claim 40 where the bitumen is petroleum based asphalt, asphalt cement, pitch, coal tar, asphalt, vacuum tar bottoms, resid, performance grade asphalt, flux, petroleum products, other hydrocarbons, or combinations thereof.

42. The method of claim 1 further comprising recovering the delinked polymer-bitumen composite from the mixing device and transforming the delinked polymer-bitumen composite into a form that is suitable for storage and transportation.

43. The method of claim 42 where the form that is suitable for storage and transportation is pellet, particulate, particle, or combinations thereof.

44. The method of claim 1 further comprising mixing the delinked polymer-bitumen composite with additional bituminous material to produce a delinked polymer modified bitumen.

45. The method of claim 44 further comprising transporting the delinked polymer-bitumen composite to a secondary mixing location prior to mixing the delinked polymer-bitumen composite with additional bituminous material.

46. A delinked polymer-bitumen composite comprising:
sulfur-cured elastomeric material having a vulcanized network and a plurality of polymer backbones;
at least one rubber accelerator and at least one activator in sufficient quantities to delink the vulcanized network of the sulfur-cured elastomeric material; and
at least one bituminous material,
where the sulfur-cured elastomeric material, the rubber accelerator, the activator, and the bituminous material are mixed under high shear conditions at a temperature greater than 70° C. to produce the delinked polymer-bitumen composite.

47. The composite of claim 46 where the activator comprises metal oxides, zinc di-2-ethylhexoate, zinc di-2-ethyloctoate, derivatives thereof, or combinations thereof.

48. The method of claim 47 where the metal oxide is zinc oxide, magnesium oxide, derivatives thereof, or combinations thereof.

49. The composite of claim 46 further comprising a diol or an alcohol.

50. The composite of claim 46 where the sulfur-cured elastomeric material comprises recycled rubber products.

51. The composite of claim 46 where the sulfur-cured elastomeric material comprises natural rubber, synthetic rubber, styrene-butadiene rubber, or combinations thereof.

52. The composite of claim 46 where the rubber accelerator comprises dithiocarbamates, guanidines, sulfenamides, thiozoles, thiourea, thiurams, derivatives thereof, or combinations thereof.

53. The composite of claim 52 where the dithiocarbamates are metal salts of dimethyldithiocarbamate, diethyldithiocarbamate, dibutyldithiocarbamate, diamyldithiocarbamate, derivatives thereof, or combinations thereof, where the metal is zinc, bismuth, cadmium, copper, lead, or any other transitional metal from groups 3 through 12, other metal from groups 13 through 15, metalloids, or selenium.

54. The composite of claim 52 where the guanidines are N,N′-di-ortho-tolyquanine or N,N′-diphenyl-gaunidine.

55. The method of claim 52 where the sulfonamides are N-cyclohexyl-2-benzothiazolesulfenamide or 4-morpholinyl-2-benzothiayl disulfide.

56. The method of claim 52 where the thiozoles are 2-mercaptobenzothiazole or benzothiazyl disulfide.

57. The method of claim 52 where the 2-mercaptobenzothiazole is zinc 2-mercaptobenzothiazole.

58. The method of claim 52 where the thiourea is trimethylthiourea or 1,3-Diethylthiourea.

59. The method of claim 52 where the thiurams are tetramethylthiuram disulfide, tetraethylthiuram disulfide, or tetrabutylthiuram disulfide.

60. The composite of claim 52 where cadmium or magnesium are substituted for zinc implemented in the rubber accelerator, the activator, or both.

61. The composite of claim 46 where the sulfur-cured elastomeric material, the rubber accelerator, the activator, and the bituminous material are mixed under high shear conditions at a temperature greater than 100° C. to produce the delinked polymer-bitumen composite.

62. The composite of claim 46 where the sulfur-cured elastomeric material, the rubber accelerator, the activator, and the bituminous material are mixed under high shear conditions at a temperature greater than 125° C. to produce the delinked polymer-bitumen composite.

63. The composite of claim 46 where the bituminous material is bitumen.

64. The composite of claim 63 where the bitumen is petroleum based asphalt, asphalt cement, pitch, coal tar, asphalt, vacuum tar bottoms, resid, performance grade asphalt, flux, petroleum products, other hydrocarbons, or combinations thereof.

65. A delinked polymer modified bitumen comprising:
a delinked polymer-bitumen composite comprising:
sulfur-cured elastomeric material having a vulcanized network and a plurality of polymer backbones;
at least one rubber accelerator and at least one activator in sufficient quantities to delink the vulcanized network of the sulfur-cured elastomeric material; and
at least one bituminous material, where the sulfur-cured elastomeric material, the rubber accelerator, and the bituminous material are mixed under high shear conditions at a temperature greater than 70° C. to produce the delinked polymer-bitumen composite; and
additional bituminous material.
